(19) United States
(12) Patent Application Publication
(10) Pub. No.: US 2009/0160874 A1
(43) Pub. Date: Jun. 25, 2009

(54) Method for adjusting image output of a digital photo frame and related digital photo frame

(76) Inventor: Pin-Hsien Su, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 12/036,288

(22) Filed: Feb. 24, 2008

(30) Foreign Application Priority Data
Dec. 19, 2007 (TW) 096148646

(51) Int. Cl. G09G 5/373

(52) U.S. Cl. 345/660

(57) ABSTRACT

A method for adjusting image output of a digital photo frame comprising storing a plurality of digital image data, displaying the plurality of digital image data, measuring a distance between the digital photo frame and a user, and adjusting display modes of the plurality of digital image data according to the distance between the digital photo frame and the user.

### BACKGROUND OF THE INVENTION

1. Field of the Invention

The present invention relates to a method and related digital photo frame for adjusting image output of a digital photo frame, and more particularly to, a method and related digital photo frame for automatically adjusting display modes of digital image data instead of manual adjustment for convenience.

2. Description of the Prior Art

With the advancement of technology, using consumer electronic products, such as televisions, computer monitors, digital cameras or mobile phones, to browse digital images has become a part of daily life. At the present time, a digital photo frame, a combination of an LCD (liquid crystal display) panel and a photo frame, is designed for replacing a traditional photo frame.

Generally, a digital photo frame only provides functions of image display for continuously displaying an image or a series images as a slide show. Other digital photo frames may include functions of switching browsing modes with different image sizes, luminance, contrast ratio, or saturation. However, these functions are performed manually and cannot be automatically performed by the prior art digital photo frame.

### SUMMARY OF THE INVENTION

It is therefore a primary objective of the claimed invention to provide a method and related digital photo frame for adjusting image output of a digital photo frame.

The present invention discloses a method for adjusting image output of a digital photo frame comprising storing a plurality of digital image data, displaying the plurality of digital image data, measuring a distance between the digital photo frame and a user, and adjusting display modes of the plurality of digital image data according to the distance between the digital photo frame and the user.

The present invention further discloses a digital photo frame for automatic adjusting image output comprising a storage unit for storing a plurality of digital image data, a display unit coupled to the storage unit, for displaying the plurality of digital image data, a measurement unit for measuring a distance between the digital photo frame and a user, and a control unit coupled to the display unit and the measurement unit, for adjusting display modes of the plurality of digital image data according to the distance between the digital photo frame and the user.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a flowchart of a process for adjusting image output of a digital photo frame according to an embodiment of the present invention.

FIG. 2 is a schematic diagram of a digital photo frame according to an embodiment of the present invention.

### DETAILED DESCRIPTION

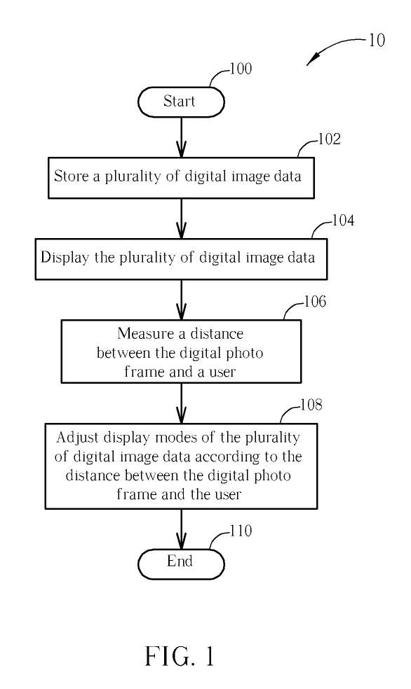

Please refer to FIG. 1. FIG. 1 is a flowchart of a process 10 for adjusting image output of a digital photo frame according to an embodiment of the present invention. The process 10 comprises the following steps:

Step 100: Start.

Step 102: Store a plurality of digital image data.

Step 104: Display the plurality of digital image data.

Step 106: Measure a distance between the digital photo frame and a user.

Step 108: Adjust display modes of the plurality of digital image data according to the distance between the digital photo frame and the user.

Step 110: End.

According to the process 10, the present invention can automatically adjust the display modes of digital image data according to the distance between the digital photo frame and the user. Therefore, needless to press a key or knob by a user, the present invention can automatically adjust the display modes of digital image data according to the distance between the digital photo frame and the user. In addition, the distance between the digital photo frame and the user is preferably measured by a sensing device, such as a passive infrared ray sensor.

For example, the present invention can automatically adjust the display modes of digital image data according to the distance between the digital photo frame and the user. That is, the digital photo frame can perform a display mode to display a single image data when the distance between the digital photo frame and the user is far. When the distance between the digital photo frame and the user gets closing, the digital photo frame can perform another mode to display multiple image data. Therefore, as the distance between the digital photo frame and the user changes, the digital photo frame can automatically adjust the display modes of digital image data without manual control of the user.

Similarly, the present invention further can automatically adjust attributes of digital image data, such as contrast ratio, luminance, resolution or saturation, according to the distance between the digital photo frame and the user. For example, the present invention can automatically decrease the resolution of digital image data when the distance between the digital photo frame and the user is far. As a result, as the distance between the digital photo frame and the user changes, the digital photo frame can automatically adjust the attributes of digital image data, such as contrast ratio, luminance, resolution or saturation, without manual control of the user.

In addition, when the distance between the digital photo frame and the user is smaller than a specific value, e.g. 1 meter, the present invention can automatically control the digital photo frame to display digital image data. Oppositely, when the distance between the digital photo frame and the user is greater than the specific value, the present invention can automatically trigger the digital photo frame to display a default image, e.g. a calendar or a clock. In this situation, the digital photo frame can automatically display the default image.

On the other hand, for reducing power consumption, the present invention can stop the display function of the digital photo frame when a period that the distance between the digital photo frame and the user is greater than the specific value is longer than a default period, and that is, there is no user located in a specific range of the digital photo frame for the default period.

Moreover, when the digital photo frame displays the plurality of digital image data by a slide show, the present invention can automatically adjust a display rate of the plurality of digital image data in the slide show mode according to the distance between the digital photo frame and the user. For example, when the user is close to the digital photo frame, the present invention can automatically decrease the display rate of the plurality of digital image data in the slide show mode, so as to make the user clearly browse each digital image data.

Therefore, according to the process 10, the present invention can automatically adjust the display modes of digital image data according to the distance between the digital photo frame and the user without manual control of the user, so as to enhance the utility convenience.

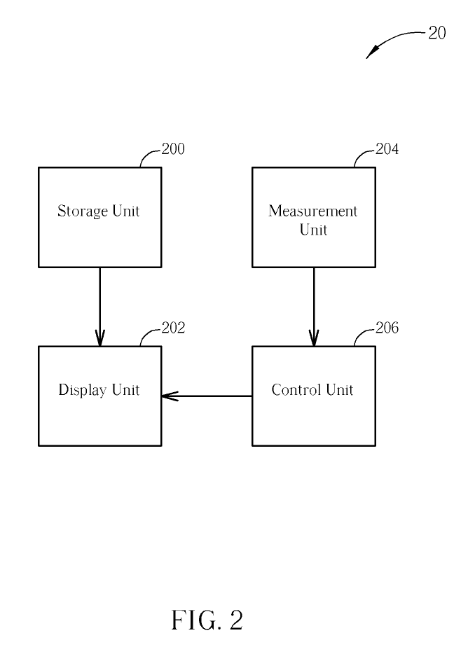

In terms of implementation of the process 10, please refer to FIG. 2. FIG. 2 is a schematic diagram of a digital photo frame 20 according to an embodiment of the present invention. The digital photo frame 20 can automatically adjust display modes of digital image data. The digital photo frame 20 comprises a storage unit 200, a display unit 202, a measurement unit 204 and a control unit 206. The storage unit 200 is utilized for storing a plurality of digital image data, and the storage unit 200 can be a memory, a hard disk, a CD, and so on. The display unit 202 is coupled to the storage unit 200, for displaying the plurality of digital image data. The measurement unit 204 is utilized for measuring a distance between the digital photo frame 20 and a user and preferably, is a passive infrared sensor. The control unit 206 is coupled to the display unit 202 and the measurement unit 204, for adjusting the display unit 202 to display digital image data according to the distance between the digital photo frame 20 and the user.

Therefore, using the control unit 206 and the measurement unit 204, the digital photo frame 20 can automatically adjust the display unit 202 to display digital image data according to the distance between the digital photo frame 20 and the user.

For example, the control unit 206 can automatically adjust the display modes or the attributes of digital image data displayed by the display unit 202. In addition, the control unit 206 can control the display unit 202 to start displaying (or stop displaying) digital image data, or to display a default image, e.g. a calendar or a clock according to the distance measured by the measurement unit 204. Moreover, when the display unit 202 displays the plurality of digital image data in a slide show mode, the control unit 206 can adjust a display rate of the display unit 202 according to the distance measured by the measurement unit 204.

As a result, in the digital photo frame 20, the control unit 206 can automatically adjust the display modes of the display unit 202 according to the distance measured by the measurement unit 204 without manual control of the user, so as to enhance the convenience for use.

In conclusion, the present invention can automatically adjust the display modes of digital image data according to the distance between the digital photo frame and the user without manual control of the user, so as to enhance the convenience for using the digital photo frame.

Those skilled in the art will readily observe that numerous modifications and alterations of the device and method may be made while retaining the teachings of the invention.

What is claimed is:

1. A method for adjusting image output of a digital photo frame comprising:
storing a plurality of digital image data;
displaying the plurality of digital image data;
measuring a distance between the digital photo frame and a user; and
adjusting display modes of the plurality of digital image data according to the distance between the digital photo frame and the user.

2. The method of claim 1, wherein measuring the distance between the digital photo frame and the user is measured by infrared sensing.

3. The method of claim 2, wherein measuring the distance between the digital photo frame and the user is by passive infrared sensing.

4. The method of claim 1, wherein adjusting the display modes of the plurality of digital image data according to the distance between the digital photo frame and the user comprises adjusting an amount of digital image data to be displayed simultaneously according to the distance between the digital photo frame and the user.

5. The method of claim 4, wherein adjusting the display modes of the plurality of digital image data according to the distance between the digital photo frame and the user further comprises triggering to display the plurality of digital image data when the distance between the digital photo frame and the user is smaller than a default value.

6. The method of claim 4, wherein adjusting the display modes of the plurality of digital image data according to the distance between the digital photo frame and the user further comprises displaying a default image different from the plurality of digital image data when the distance between the digital photo frame and the user is greater than a default value.

7. The method of claim 6, wherein the default image comprises a calendar.

8. The method of claim 4, wherein adjusting the display modes of the plurality of digital image data according to the distance between the digital photo frame and the user further comprises stopping displaying the plurality of digital image data when a period that the distance between the digital photo frame and the user is greater than a default value is longer than a default period.

9. The method of claim 1, wherein displaying the plurality of digital image data is by a slide show.

10. The method of claim 9, wherein adjusting the display modes of the plurality of digital image data according to the distance between the digital photo frame and the user comprises adjusting a display rate of the plurality of digital image data according to the distance between the digital photo frame and the user.

11. The method of claim 1 further comprising adjusting attributes of the plurality of digital image data according to the distance between the digital photo frame and the user.

12. The method of claim 11, wherein adjusting the attributes of the plurality of digital image data according to the distance between the digital photo frame and the user is adjusting contrast ratio, luminance, resolution or saturation of the plurality of digital image data according to the distance between the digital photo frame and the user.

13. A digital photo frame for automatic adjusting image output comprising:
a storage unit for storing a plurality of digital image data;
a display unit coupled to the storage unit, for displaying the plurality of digital image data;
a measurement unit for measuring a distance between the digital photo frame and a user; and
a control unit coupled to the display unit and the measurement unit, for adjusting display modes of the plurality of digital image data according to the distance between the digital photo frame and the user.

14. The digital photo frame of claim 13, wherein the measurement unit is an infrared ray sensor.

15. The digital photo frame of claim 14, wherein the infrared ray sensor is a passive infrared ray sensor.

16. The digital photo frame of claim 13, wherein the control unit is utilized for adjusting an amount of digital image data to be displayed simultaneously according to the distance between the digital photo frame and the user.

17. The digital photo frame of claim 16, wherein the control unit is further utilized for triggering to display the plurality of digital image data when the distance between the digital photo frame and the user is smaller than a default value.

18. The digital photo frame of claim 16, wherein the control unit is further utilized for displaying a default image different from the plurality of digital image data when the distance between the digital photo frame and the user is greater than a default value.

19. The digital photo frame of claim 18, wherein the default image comprises a calendar.

20. The digital photo frame of claim 16, wherein the control unit is utilized for stopping displaying the plurality of digital image data when a period that the distance between the digital photo frame and the user is greater than a default value is longer than a default period.

21. The digital photo frame of claim 13, wherein the display unit is utilized for displaying the plurality of digital image data by a slide show.

22. The digital photo frame of claim 21, wherein the display unit is utilized for adjusting a display rate of the plurality of digital image data according to the distance between the digital photo frame and the user.

23. The digital photo frame of claim 13, wherein the display unit is further utilized for adjusting attributes of the plurality of digital image data according to the distance between the digital photo frame and the user.

24. The digital photo frame of claim 23, wherein the attributes of the plurality of digital image data are contrast ratio, luminance, resolution or saturation.
